(19) United States
(12) Patent Application Publication
(10) Pub. No.: US 2009/0004348 A1
(43) Pub. Date: Jan. 1, 2009

(54) Smoker for grill

(76) Inventor: Corey Silva, Portland, OR (US)

Correspondence Address: KLARQUIST SPARKMAN, LLP, 121 SW SALMON STREET, SUITE 1600, PORTLAND, OR, 97204, US

(21) Appl. No.: 12/157,778

(22) Filed: Jun. 12, 2008

Related U.S. Application Data
(60) Provisional application No. 60/937,373, filed on Jun. 26, 2007.

(51) Int. Cl. A23B 4/052

(52) U.S. Cl. 426/315; 99/482

(57) ABSTRACT

A smoker for use with a grill, comprising a smoke-releasing material holder positionable between a heat source and food rack within a grill, at least one air diffuser positioned at least partially within the holder in air transmitting communication with the holder, and an air actuator coupled to the at least one air diffuser in air transmitting communication with the at least one air diffuser.

### PRIORITY CLAIM

This application claims the benefit of U.S. Provisional Application No. 60/937,373, filed Jun. 26, 2007, which is incorporated herein in its entirety.

### FIELD

The present invention relates to food cooking apparatus, and more particularly, to a smoker for food-cooking grills.

### BACKGROUND

Using smoke to flavor food is widely known in the art. For example, stand-alone smoker devices have been developed solely to generate smoke for flavoring food. Typically, a stand-alone smoker is in smoke transmitting communication with a food cooking apparatus, such as a grill, to introduce smoke into a food cooking environment defined by the food cooking apparatus. Food in the food cooking environment is cooked by a heat source of the food cooking apparatus and the smoke from the stand-along smoker flavors the food.

While generally efficient at producing smoke, stand-alone smokers can be bulky, expensive and impractical. In order to smoke food using a stand-alone smoker, a grill-owner must have adequate space to store and operate the smoker, which, owing to the size of conventional stand-alone smokers, may be unavailable. Further, many grill owners only occasionally desire to smoke food. Also, maintaining a stand-alone, dedicated smoker may be time consuming and costly. Accordingly, an expensive, dedicated smoker may be economically and physically impractical for such intermittent use.

In other conventional systems, a smoke-generating device is positioned within a food cooking environment to create a combination cooker/smoker system. For example, in some systems, an outdoor grill defines a food cooking environment that has a heat source, such as a gas burner or charcoal, positioned at a lower portion of the environment, a food rack positioned above the heat source, and a smoke-generating device positioned intermediate the heat source and the food rack. Typical smoke-generating devices include fixed or removable trays containing smoke-releasing material, such as wood chips or pellets. Heat from the heat source causes the smoke-releasing material to ignite or smolder, which results in smoke being released from the material. The generated smoke circulates through the food cooking environment to flavor the food on the rack.

Conventional cooker/smoker systems, such as described above, have several shortcomings. For example, many cooker/smoker systems produce an insufficient amount of smoke to provide adequate flavoring of food within the cooking environment. In cooker/smoker systems, heat from the heat source and oxygen are required for smoke-releasing material to ignite, smolder and produce smoke. The heated air from the heat source heats the smoke-releasing material and provides the oxygen necessary for igniting and smoldering the smoke-releasing material. However, because the oxygen level of the heated air has been depleted due to the combustion of the heat source material, such as natural gas or propane, there can be insufficient oxygen present in the heated air to provide sufficient ignition and/or smoldering of the smoke-releasing material. Accordingly, an insufficient amount of smoke for flavoring the food can result.

Further, conventional smoker/cooker systems typically do not provide an easy and sufficient way to adjustably control the about of smoke being produced. For example, if a greater or lesser amount of smoke is desired, many conventional smoker/cooker systems require an alteration of the heat being produced by the heat source or removal of the smoke-generating device from the food cooking environment. Increasing the heat may cook the food at an undesirable rate. Further, removing the smoke-generating device during a cooking operation can be cumbersome and dangerous. Many conventional smoker/cooker systems do not provide a way to easily adjust the smoke level during a cooking operation independent of the heat source.

### BRIEF DESCRIPTION OF THE DRAWINGS

FIG. 1 is a perspective view of a smoker device according to one exemplary embodiment.

FIG. 2 is a perspective view of a smoke-releasing material holder and diffusion portion of the smoker device of FIG. 1

FIG. 3 is a top plan view of the smoke-releasing material holder and diffusion portion of the smoker device of FIG. 1.

FIG. 4 is an elevation end view of the smoke-releasing material holder of the smoker device of FIG. 1.

FIG. 5 is an elevation side view of the smoke-releasing material holder of the smoker device of FIG. 1.

FIG. 6 is a cross-sectional front view of a grill having a smoker device according to an exemplary embodiment.

### DETAILED DESCRIPTION

Described herein are several embodiments of a smoker device for use with a cooking apparatus. In certain implementations, the smoker device is positioned within the food cooking environment of the cooking apparatus to provide an economical and convenient way to smoke food. The smoker device, according to some implementations, provides increased smoke-producing characteristics compared to conventional smoker devices. Further, in some embodiments, the smoker device facilitates adjustable, in situ, controllability of the smoke level produced by the device independent of the level of heat produced by the heat source of the cooking apparatus.

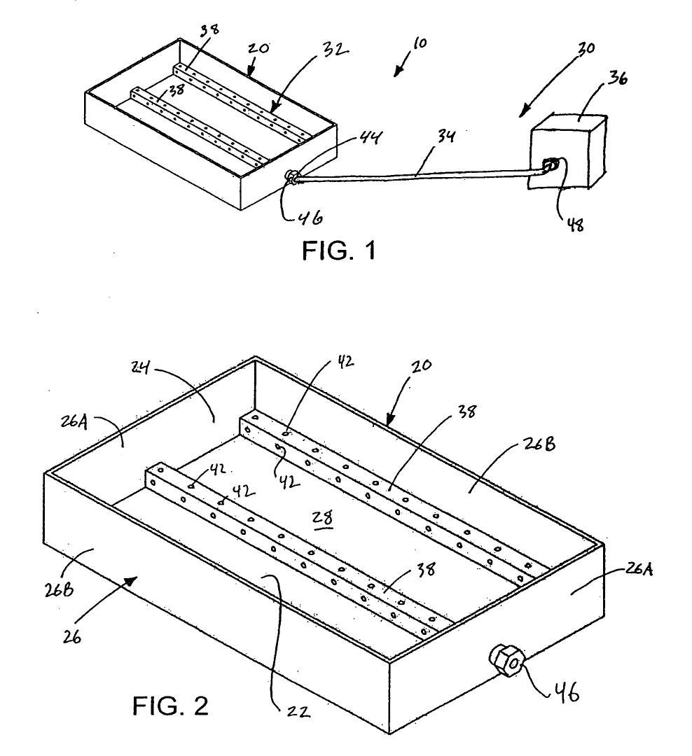

Referring to FIG. 1, and according to one embodiment, a smoker device 10 includes a smoke-releasing material holder 20, e.g., a container, receptacle or box, and an air induction system 30 coupled to the holder. With reference to FIG. 2, the material holder 20 includes a closed bottom end 22 and an open top end 24. The closed bottom end 22 is coupled to the open top end 24 by sides 26 extending between, and generally transversely relative to, the top and bottom ends. The sides 26 include first spaced-apart sides 26A extending parallel to each other and second spaced-apart sides 26B extending parallel to each other and transversely from the sides 26A. As shown, the bottom end 22 and each side 26 has a generally rectangular shape, such that the holder 20 has a generally elongate cube shape. However, in some embodiments, the holder 20 can have any one of various shapes, such as cylindrical, prismatic, cubic, etc. In the illustrated embodiments, the bottom end 22 and sides 26 are made from substantially planar, thin-walled sheets of a conductive material. Preferably, the conductive material is a rigid, strong, and durable material with a high melting temperature, such as steel.

Also, although in the illustrated embodiments, the closed end 22 of the holder 20 is completely closed, or free of openings, and the open end 24 of the holder 20 is completely open, or free of obstructions, in other embodiments, the closed end can be partially closed and the open end can be partially open. For example, in certain implementations, the closed end 22 can have one or more openings (not shown) large enough to allow direct heat transfer from a heat source to the smoke-releasing material, but small enough to prevent the smoke-releasing material to fall through. Likewise, in certain implementations, the open end 24 can be a partially open cover, such as a mesh, vented, or louvered cover, to control or direct smoke output, or keep contaminants, such as grease, from accumulating within the holder.

The holder 20 includes a material containment area 28 defined by the bottom end 22 and sides 26. The material containment area 28 is sized to receive and contain a predetermined amount of smoke-releasing material. Accordingly, the bottom end 22 and sides 26 can have any of a number of shapes and sizes to define a material containment area 28 sufficiently sized to accommodate a desire amount of smoke-releasing material (not shown) for any of variously sized and shaped cooking apparatus.

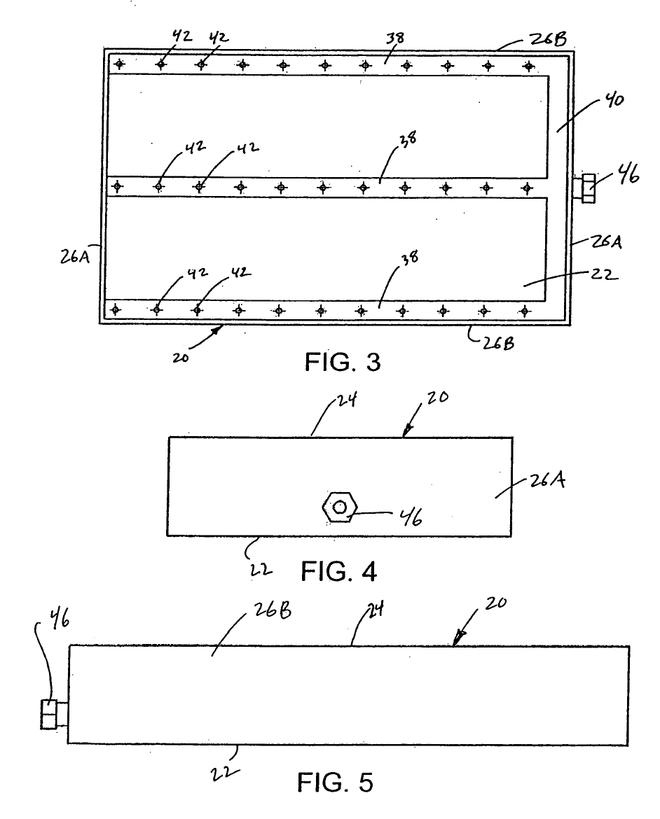

Referring back to FIG. 1, the air induction system 30 includes an air diffusion portion 32, feed line 34 and forced air actuator 36. The air diffusion portion 32 is positioned within the material containment area 28 and includes one or more air diffusers 38 coupled to and in air receiving communication with an air manifold 40 (see FIG. 3). Each diffuser 38 includes a length of tubular material defining a generally hollow passageway through which air is allowed to flow. As shown, the diffusers 38 each have a generally square cross-sectional shape. However, in other embodiments, the diffusers 38 have any of various other cross-sectional shapes, such as, for example, rectangular, triangular, etc.

A plurality of spaced-apart apertures 42 are formed in and extend through the walls of each diffuser 38. As shown, apertures 42 are formed in each of the sides of the diffusers exposed to the material containment area 28 and evenly distributed along a length of the diffusers 38. The apertures 42 can be formed in the diffusers 38 in any of various patterns, such as staggered, or be randomly arranged. Similar to the diffusers 38, the manifold 40 includes a length of tubular material defining a generally hollow passageway. An aperture (not shown) corresponding with each diffuser 38 is formed in the wall of the manifold. Each diffuser 38 is secured to the manifold 40, such as by welding, fastening or other coupling technique, over a respective aperture in the manifold such that the hollow passageway is in alignment and air receiving communication with a respective aperture of the manifold. Alternatively, the diffusers 38 can be formed integrally with, e.g., as a one-piece unit with, the manifold 40.

In the illustrated embodiments, the diffusion portion 32 includes three spaced-apart diffusers 38 extending generally parallel to each other and the first sides 26B along a length of the material holder 20. In other embodiments, the diffusion portion 32 can include more or fewer than three diffusers 38 and the diffusers can extend generally parallel to second sides 26A along a width of the material holder 20. Alternatively, the diffusers 38 can be other than substantially straight. For example, the diffusers 38 can be generally circular or ovular, such as with a holder 20 having a circular or ovular shape.

Referring to FIG. 1, the air manifold 40 is in air receiving communication with an outlet end 44 of the feed line 34 via a fitting 46 formed in or coupled to a side 26, such as side 26A, of the holder 20. The feed line 34 includes a length of tubing, piping or braided line made of a heat resistant material, such as steel, fiberglass or copper, or coated with a heat resistant material, such as silicone rubber or a ceramic material.

The inlet end 48 of the feed line 34 is coupled to and in air receiving communication with the forced air actuator 36. The forced air actuator 36 can be any of various devices, such as a pump, fan, bellows, etc, configured to pump air into the feed line 34. In certain embodiments, the forced air actuator 36 is selectively controllable to force air into the feed line 34 at different rates. In certain implementations, the smoker device 10 includes a forced air actuator control assembly (not shown) in communication with the actuator 36. The control assembly can be operable by a user of the smoker device 10 to vary the rate of air into the feed line 24, and thus the material containment area 28 as will be described in more detail below.

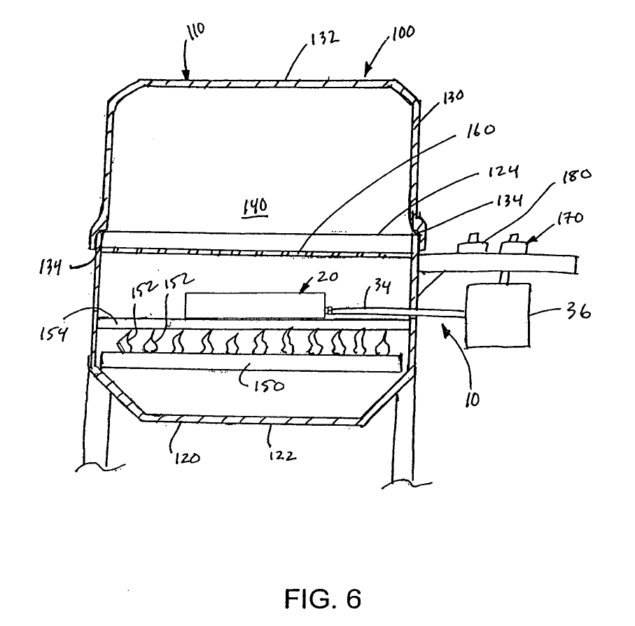

In certain, embodiments, the smoker device 10 is used in cooperation with a grill apparatus, such as gas grill 100 shown in FIG. 6. Gas grill 100 can be any of various gas grills known in the art or a gas grill specifically suited for use with the smoker device 10. In other words, the smoker device 10 can be retrofitted into an existing gas grill 100 to covert the grill from a cooker to a combination smoker/cooker. Alternatively, the smoker device 10 can be installed in a gas grill at the point of manufacture of the grill and sold to an end user as a combination smoker/cooker.

Referring to FIG. 6, gas grill 100 includes a body 110 having a base 120 and lid 130. The base 120 defines a generally hollow space between a lower end 122 and an open upper end 124. Similarly, the lid 130 defines a generally hollow space between an upper end 132 and an open lower end 134. The lid 130 is coupled to the base 120 and movable (e.g., pivotable, rotatable, slidable, etc.) between an open position and a closed position. When in the closed position (shown in FIG. 6), the interface between the base 120 and lid 130 forms an at least partial seal and the open upper end 124 of the base and open lower end 134 of the lid are adjacent each other such that the hollow spaces of the base and lid form a food cooking/smoking environment, or space, 140. The grill 100 includes a heat source, such as burners 150, secured to and positioned within the base 120 intermediate the lower end 122 and open upper end 124. The grill 100 further includes a food rack, or grid, 160 positioned within the base 120 intermediate the burners 150 and the open upper end 124.

The holder 20 is positioned within the base 120 intermediate the burners 150 and the food rack 160. The holder 20 extends generally parallel to the food rack 160 with the open top end 24 facing the food rack. In the illustrated embodiments, the holder 20 is supported by a sear plate 154 secured to the base 120 over the burners 150. In many conventional grills, one or more sear plates are provided to protect the burners from falling grease and food. Further, sear plates can conduct heat from the heat source and provide radiant heat to the food rack 160. Similarly, in addition to, or in place of, sear plates, some conventional grills include a briquette rack and briquettes positioned between the heat source and the food rack. In these grills, the holder 20 can be supported on top of the briquettes. Alternatively, the holder 20 can be mounted to the base 120 by one or more stand-off brackets (not shown) secured to the base.

In certain implementations, the holder 20 is removable if, for example, the smoke-releasing material needs to be replenished, the holder requires maintenance or replacement, or the user no longer desires to smoke food and wants to use the grill only to cook food. Accordingly, in certain implementations, the grill 100 can operate in a smoker/cooker mode by positioning the holder 20 within the grill and operating the smoker device 10 as described above, or in a cooker mode by removing the holder from the grill.

The feed line 34 extends from the holder 20 at a location within the base 120 to the forced air actuator 36 at a location external to the base via an aperture 126 formed in the base. As shown, the feed line 34 extends through a small aperture formed in a side of the base. However, in certain implementations, the grill can include a slot formed in the base through which the holder 20 is inserted to position the holder within the grill and from which the holder is removed. In these implementations, the feed line 34 can extend through the slot when the holder is positioned within the grill.

In use, the lid 130 is moved into the open position and food to be cooked is placed on the rack 160. Prior to, or after, placing food on the rack 160, one or more of the burners 150 are activated to produce a flame 152. Heated gas from the flame rises and cooks the food. As the heated gas rises, it contacts the holder 20 causing it to rise in temperature. Once the temperature of the holder 20 reaches a predetermined level, which is dependent on the combustability of the smoke-releasing material contained by the holder, the material ignites, begins to smolder, and produces smoke. The smoke is released into the food cooking environment 140 via the open top end 24 of the holder 20. As discussed above, the heated gas rising into contact with and around the holder 20 has a substantially reduced level of oxygen in relation to the air outside of the grill due to the combustion the heat source fuel.

The forced air actuator 36 is operable to supply fresh air from outside the grill 100 into the material containment area 28 of the holder 20 via the air diffusion portion 32. More specifically, the forced air actuator 36 generates air flow through the air feed line 34 and into the air manifold 40. From the air manifold 40, the air flows into the air diffusers 38 at an approximately equivalent rate and through the apertures 42 into the material containment area 28. In certain embodiments, the apertures 42 are arranged to evenly distribute fresh air into the material containment area 28. The fresh air entering the material containment area 28 from outside the grill 100 contains more oxygen than the heated gas within the grill 100. The additional oxygen in the material containment area 28 improves ignition and smoldering performance of the smoke-releasing material to enhance the smoke output of the material.

In certain embodiments, the smoke output of the smoker 10 can be selectively controlled by operation of the forced air actuator 36 to adjust the rate of air flow into the material containment area 28. If a user desires more smoke flavoring in the food being cooked, the air flow rate into the material containment area 28 can be increased by increasing the forced air output of the actuator 36. Likewise, if a user desires less smoke flavoring in the food being cooked, the air flow rate into the material containment area 28 can be decreased by decreasing the forced air output of the actuator 36. Unlike conventional smoker/cooker devices, a user need not adjust the heat output of the heat source, or add smoke-releasing material to or take smoke-releasing material away from the holder, to adjust the amount of smoke in the grill. Further, operation of the forced air actuator 36 can be initiated by controls, such as control knob 170, in communication with the actuator and positioned near the burner control knobs, such as knob 180. Accordingly, the cooking operation of the grill 100 and smoking operation of the smoker 10 can be controlled from one convenient location.

In view of the many possible embodiments to which the principles of the disclosed smoker may be applied, it should be recognized that the above embodiments are only examples of the smoker and should not be taken as limiting the scope of the invention.

I claim:

1. A smoker for use with a grill, comprising
a smoke-releasing material holder positionable between a heat source and food rack within a grill;
at least one air diffuser positioned at least partially within the holder in air transmitting communication with the holder; and
an air actuator coupled to the at least one air diffuser in air transmitting communication with the at least one air diffuser.

2. The smoker according to embodiment 1, wherein the smoker comprises an air manifold positioned at least partially within the holder in air transmitting communication with the at least one air diffuser.

3. The smoker according to embodiment 2, wherein the at least one air diffuser comprises a plurality of diffusers.

4. The smoker according to embodiment 1, wherein the at least one air diffuser comprises a plurality of diffusers.

5. The smoker according to embodiment 1, wherein the at least one air diffuser comprises an elongate tubular element having a plurality of air outlets.

6. The smoker according to embodiment 1, wherein the air actuator is selectively controllable to control transmission of air from the air actuator to the at least one air diffuser.

7. The smoker according to embodiment 1, wherein the air actuator is coupled to the at least one air diffuser via a heat-resistant conduit.

8. A method of supplying smoke within a grill, comprising:
positioning a smoke-releasing material container within a grill between a heat source and food grid of the grill;
supplying air from a location external to the grill to the smoke-releasing material container; and
heating smoke-releasing material contained within the container.

9. The method of embodiment 8, wherein supplying air comprises actuating a forced air device in air transmitting communication with the smoke-releasing material and positioned external to the grill.

10. The method of embodiment 8, further comprising smoldering smoke-releasing material contained within the smoke-releasing container.

11. The method of embodiment 8, wherein supplying air comprises transmitting air through an air manifold system positioned within the smoke-releasing container.

12. The method of embodiment 11, wherein transmitting air comprises transmitting air through a plurality of spaced-apart air diffusers each having a plurality of air outlets.

13. A grill for cooking and smoking food, comprising:
a food cooking portion comprising a heat source and a food rack;
a wood chip box positioned within the food cooking portion between the heat source and the food rack;
a forced air system comprising at least one air diffuser positioned within the wood chip box in air receiving communication with an air transfer device external to the food cooking portion.

14. The grill of embodiment 13, wherein the heat source is a natural gas burner.

15. The grill of embodiment 13, wherein the air transfer device is a variable speed air pump.

16. The grill of embodiment 13, wherein the at least one diffuser is coupled to the air transfer device via heat-resistant tubing.

17. The grill of embodiment 13, further comprising heat source controls, wherein the forced air system comprises an air transfer device control positioned proximate the heat source controls.

18. The grill of embodiment 13, wherein the forced air system is operable to control a smoke output from wood chips retained in the wood chip box, wherein the smoke output is controlled independent of the quantity of wood chips and the level of heat generated by the heat source.
